(19) United States
(12) Patent Application Publication
(10) Pub. No.: US 2018/0270344 A1
(43) Pub. Date: Sep. 20, 2018

(54) UNCONFIRMED-INFORMATION OUTPUT APPARATUS, AND UNCONFIRMED-INFORMATION OUTPUT METHOD

(71) Applicant: MITSUBISHI ELECTRIC CORPORATION, Tokyo (JP)

(72) Inventor: Toshio KAWAGISHI, Tokyo (JP)

(73) Assignee: MITSUBISHI ELECTRIC CORPORATION, Tokyo (JP)

(21) Appl. No.: 15/532,941

(22) PCT Filed: Mar. 19, 2015
(86) PCT No.: PCT/JP2015/058173

§ 371 Date: Jun. 2, 2017

(51) Int. Cl. H04M 1/725; G07C 5/00; G07C 5/08

(52) U.S. Cl. CPC H04M 1/72577; G07C 5/008; H04W 88/02; G07C 5/0858; G07C 5/0825

(57) ABSTRACT

The present information has been conceived in view of the problems, and has an object of controlling, in an in-vehicle unconfirmed-information output apparatus, output timing of unconfirmed information. An unconfirmed-information output apparatus according to the present invention is an apparatus mounted on a vehicle, and includes: a communication unit that communicates with a carry-in terminal brought into the vehicle to obtain unconfirmed information from the carry-in terminal; a driving state obtaining unit that obtains a driving state of the vehicle; and an output controller that controls output of the unconfirmed information on the basis of the driving state.

### TECHNICAL FIELD

The present invention relates to a technique for controlling, by an in-vehicle device, output of unconfirmed information held by a terminal brought into a vehicle.

### BACKGROUND ART

Conventionally, in-vehicle information devices such as navigation apparatuses have performed proximity communication with a carry-in terminal such as a mobile phone of a driver that is brought into the vehicle, and have displayed information held by the carry-in terminal.

Patent Document 1 proposes, for example, when a carry-in terminal has unconfirmed information such as unread e-mail information, a technique of an in-vehicle information device for obtaining the unconfirmed information from the carry-in terminal and notifying a user of the unconfirmed information. The user is notified by display or output in voice.

### PRIOR-ART DOCUMENTS

### Patent Documents

Patent Document 1: Japanese Patent Application Laid-Open No. 2010-74215

### SUMMARY

### Problems to be Solved by the Invention

According to the technique of Patent Document 1, the user can receive notification on the unconfirmed information from the in-vehicle information device while driving. For example, when the unconfirmed information is unread mail information, the user can know that the mails received by the carry-in terminal include an unconfirmed mail.

However, even when the unconfirmed information is displayed on a display of the in-vehicle information device, the user sometimes does not notice the unconfirmed information while driving. Even if the user notices the unconfirmed information while driving, it is hard for the user to read the information displayed on the display or perform a certain operation in response to the information.

The present information has been conceived in view of the problems, and has an object of controlling, in an in-vehicle unconfirmed-information output apparatus, output of unconfirmed information held by a terminal brought into a vehicle so as not to interfere with driving.

### Means to Solve the Problems

An unconfirmed-information output apparatus according to the present invention is an apparatus mounted on a vehicle, and includes: a communication unit that communicates with a carry-in terminal brought into the vehicle to obtain unconfirmed information from the carry-in terminal; a driving state obtaining unit that obtains a driving state of the vehicle; and an output controller that controls output of the unconfirmed information on the basis of the driving state.

### Effects of the Invention

An unconfirmed-information output apparatus according to the present invention is an apparatus mounted on a vehicle, and includes: a communication unit that communicates with a carry-in terminal brought into the vehicle to obtain unconfirmed information from the carry-in terminal; a driving state obtaining unit that obtains a driving state of the vehicle; and an output controller that controls output of the unconfirmed information on the basis of the driving state. Accordingly, since output of the unconfirmed information is controlled on the basis of the driving state, the output can be controlled so that the unconfirmed information is displayed, for example, only during the stop of the vehicle. Accordingly, the unconfirmed information can be output so as not to interfere with driving.

The object, features, aspects and advantages of the present invention will become more apparent from the following detailed description and the accompanying drawings.

### BRIEF DESCRIPTION OF DRAWINGS

FIG. 1 is a block diagram illustrating a configuration of an unconfirmed-information output apparatus according to Embodiment 1.

FIG. 2 is a block diagram illustrating a configuration of an unconfirmed-information output apparatus according to Embodiment 2.

FIG. 3 illustrates a hardware configuration of the unconfirmed-information output apparatus according to Embodiment 2.

FIG. 4 illustrates how the unconfirmed-information output apparatus according to Embodiment 2 controls output of unconfirmed information.

FIG. 5 is a flowchart illustrating operations of the unconfirmed-information output apparatus according to Embodiment 2.

FIG. 6 is a time chart illustrating the operations of the unconfirmed-information output apparatus according to Embodiment 2.

FIG. 7 is a block diagram illustrating a configuration of an unconfirmed-information output apparatus according to Embodiment 3.

FIG. 8 is a block diagram illustrating a configuration of a passenger determining unit according to Embodiment 3.

FIG. 9 is a flowchart illustrating operations of the passenger determining unit according to Embodiment 3.

FIG. 10 is a flowchart illustrating the operations of the passenger deteiinining unit according to Embodiment 3.

FIG. 11 is a flowchart illustrating operations of the unconfirmed-information output apparatus according to Embodiment 3.

FIG. 12 illustrates how the unconfirmed-information output apparatus according to Embodiment 3 controls output of unconfirmed information.

### DESCRIPTION OF EMBODIMENTS

### A. Embodiment 1

### [A-1. Configuration]

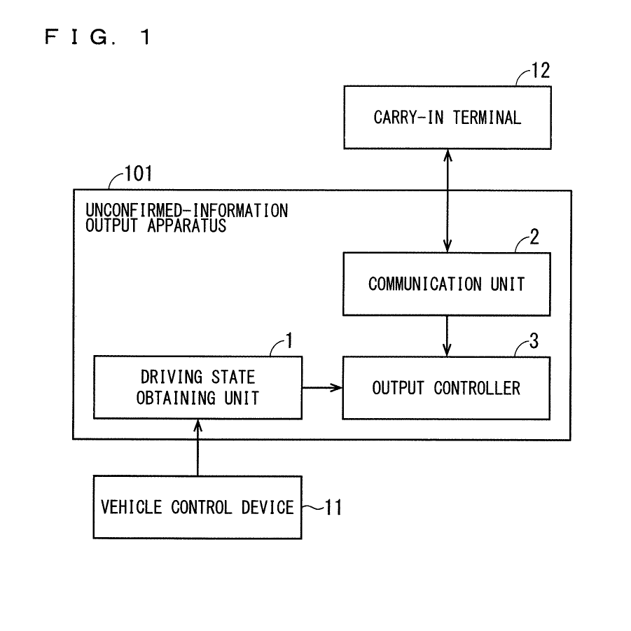

FIG. 1 is a block diagram illustrating a configuration of an unconfirmed-information output apparatus 101 according to Embodiment 1 of the present invention. The unconfirmed-information output apparatus 101 is an apparatus mounted on a vehicle. The unconfirmed-information output apparatus 101 obtains unconfirmed information from a carry-in terminal 12, and outputs the unconfirmed information according to a driving state of the vehicle.

The apparatuses “mounted on a vehicle” in this Description are not limited to apparatuses continually mounted on a vehicle but include an apparatus brought into a vehicle whenever necessary. Furthermore, the “vehicle” is a vehicle on which the unconfirmed-information output apparatus 101 is mounted, and indicates a vehicle boarded by the user. Furthermore, the “carry-in terminal” indicates a mobile communication terminal of the user that is brought into the vehicle. Examples of such a terminal include a smartphone and a personal data assistance (PDA). Furthermore, the “unconfirmed information” is information unconfirmed by the user that is included in the information received by the carry-in terminal 12. Examples of the unconfirmed information include a missed call history, unread mail information, a confirmation message on update program, an error confirmation message, etc.

If the carry-in terminal 12 has an incoming call but the user does not notice it, the carry-in terminal 12 has a missed call history. When the user confirms the missed call history and performs a certain operation, for example, pressing a confirmation button or making a call to the caller, the unconfirmed state of the missed call history is eliminated. Unless the user performs any of these operations, the carry-in terminal 12 still has the missed call history as the unconfirmed information.

Generally speaking, since the user who is driving a vehicle does not often operate the carry-in terminal 12, the user does not notice the unconfirmed information. Here, the unconfirmed-information output apparatus 101 obtains the unconfirmed information held by the carry-in terminal 12 and causes an in-vehicle output device to output the unconfirmed information to notify the user of the unconfirmed information.

As illustrated in FIG. 1, the unconfirmed-information output apparatus 101 includes a driving state obtaining unit 1, a communication unit 2, and an output controller 3. The driving state obtaining unit 1 obtains a driving state from a vehicle control device 11 that controls driving of a vehicle. This driving state includes a state indicating that the vehicle is traveling or stops.

The communication unit 2 communicates with the carry-in terminal 12 to obtain the unconfirmed information. The output controller 3 obtains the driving state of the vehicle from the driving state obtaining unit 1 and obtains the unconfirmed information of the carry-in terminal 12 from the communication unit 2 to control output timing of the unconfirmed information according to the driving state of the vehicle.

[A-2. Advantages]

The unconfirmed-information output apparatus 101 according to Embodiment 1 includes: the communication unit 2 that communicates with the carry-in terminal 12 brought into the vehicle to obtain unconfirmed information from the carry-in terminal; the driving state obtaining unit 1 that obtains a driving state of the vehicle; and an output controller 3 that controls output of the unconfirmed information on the basis of the driving state. Accordingly, it is possible to control output on the basis of the driving state, for example, prevent the unconfirmed information from being output while the vehicle is traveling or cause the unconfirmed information to be output during the stop of the vehicle. Thus, the output of the unconfirmed information can be controlled so as not to interfere with driving.

### B. Embodiment 2

### [B-1. Configuration]

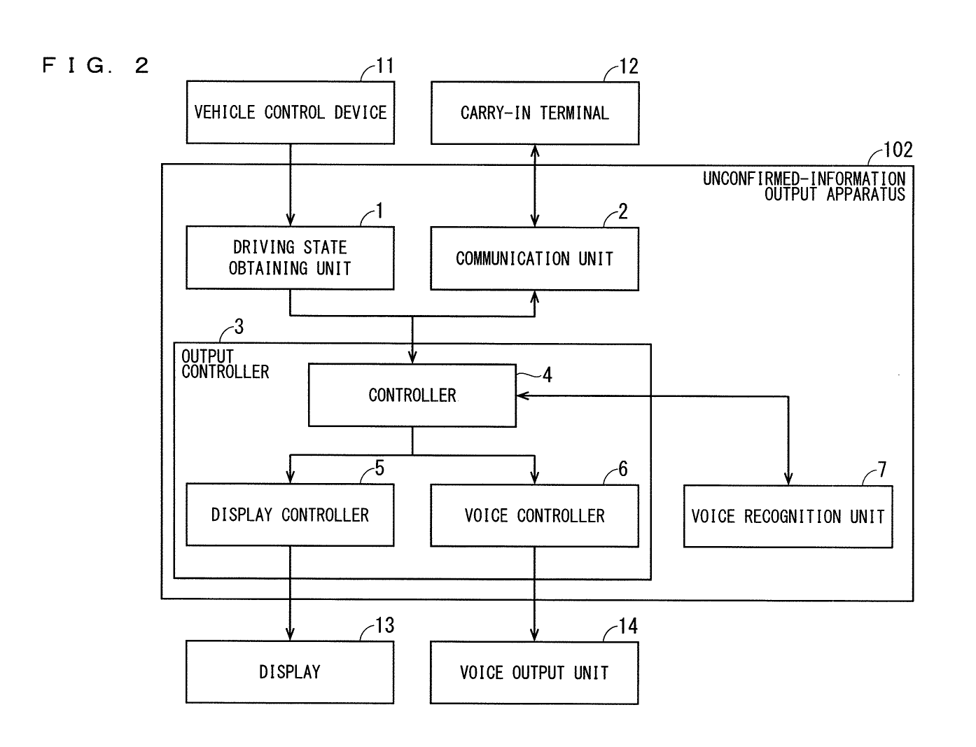

FIG. 2 is a block diagram illustrating a configuration of an unconfirmed-information output apparatus 102 according to Embodiment 2 of the present invention. The unconfirmed-information output apparatus 102 is an apparatus mounted on a vehicle similarly as the unconfirmed-information output apparatus 101, obtains unconfirmed information from the carry-in terminal 12, and outputs the unconfirmed information according to a driving state of the vehicle.

The unconfirmed-information output apparatus 102 includes a voice recognition unit 7 in addition to the configuration of the unconfirmed-information output apparatus 101. Furthermore, the output controller 3 includes a controller 4, a display controller 5, and a voice controller 6. The voice recognition unit 7 performs voice recognition under the control of the controller 4. In other words, the unconfirmed-information output apparatus 102 can perform an operation according to a voice of the user. For example, when a missed call history is displayed on the display 13 as the unconfirmed information and the user utters “call”, the voice recognition unit 7 recognizes the voice and outputs the recognition data to the controller 4. Then, the controller 4 controls the carry-in terminal 12 through the communication unit 2, and causes the carry-in terminal 12 to call the caller of the missed call.

The display controller 5 controls display of the display 13. Although FIG. 2 illustrates the display 13 as separately configured from the unconfirmed-information output apparatus 102, the display 13 may be included in the unconfirmed-information output apparatus 102. The display 13 is a display such as a liquid crystal display (LCD).

The voice controller 6 controls output in voice from a voice output unit 14. Although FIG. 2 illustrates the voice output unit 14 as separately configured from the unconfirmed-information output apparatus 102, the voice output unit 14 may be included in the unconfirmed-information output apparatus 102. The voice output unit 14 is, for example, a speaker.

The controller 4 controls the entire unconfirmed-information output apparatus 102. The controller 4 controls particularly the output timing of the unconfirmed information of the carry-in terminal 12 that is obtained through the communication unit 2. Specifically, the controller 4 determines whether to cause the display 13 to display the unconfirmed information or cause the voice output unit 14 to output the unconfirmed information as voice, on the basis of the driving state obtained from the driving state obtaining unit 1.

The driving states of the vehicle that are obtained from the driving state obtaining unit 1 include “automatic driving”, “stop”, and “manual driving”. In other words, the vehicle on which the unconfirmed-information output apparatus 102 is mounted can be automatically and manually driven. The driving state obtaining unit 1 obtains, from the vehicle control device 11, a driving mode indicating whether the vehicle is being driven automatically or manually. Furthermore, the driving state obtaining unit 1 obtains a velocity of the vehicle. Then, the driving state obtaining unit 1 determines whether the vehicle is traveling or stops, on the basis of the velocity of the vehicle. When the vehicle is traveling, the driving state obtaining unit 1 determines whether the vehicle is being driven automatically or manually, on the basis of the driving mode. Accordingly, the driving state obtaining unit 1 obtains information for determining a driving state and then determines the driving state by itself to obtain it, without directly obtaining the driving state from the vehicle control device 11. The driving state obtaining unit 1 may directly obtain information indicating the driving state from the vehicle control device 11.

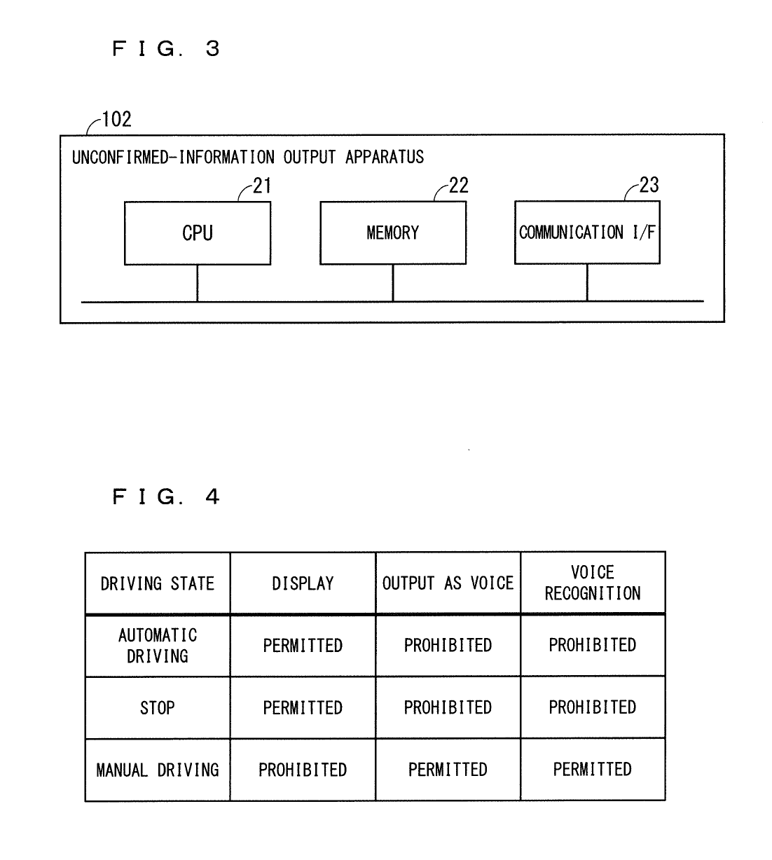

FIG. 3 illustrates a hardware configuration of the unconfirmed-information output apparatus 102. The unconfirmed-information output apparatus 102 is implemented by a central processing unit (CPU) 21, a memory 22, and a communication interface (I/F) 23. The CPU 21 causes a program stored in the memory 22 such as random-access memory (RAM) to implement the driving state obtaining unit 1, the output controller 3, and the voice recognition unit 7 as functions of the CPU 21. These may be implemented by, for example, the CPUs 21 in close cooperation with each other. Furthermore, the communication unit 2 is implemented by the communication I/F 23.

### [B-2. Operations]

Next, output control of the unconfirmed information by the controller 4 will be described. FIG. 4 illustrates how the controller 4 controls output of the unconfirmed information according to a driving state. When the vehicle stops, the controller 4 permits display. In other words, the controller 4 controls the display controller 5 so that the unconfirmed information is displayed on the display 13. For example, when the unconfirmed information is a missed call history, the controller 4 instructs the display controller 5 to display on the display 13 “incoming call from Mr. A at 14:30”, etc. in text. This is because displaying the unconfirmed information during the stop of the vehicle does not interfere with the driving of the user and the user has time to confirm the unconfirmed information. However, the controller 4 prohibits output in voice. In other words, the voice output unit 14 does not output the unconfirmed information. Since the unconfirmed information is displayed on the display 13, the output in voice is unnecessary.

While the vehicle is being manually driven, the controller 4 prohibits display and permits output in voice. In other words, the unconfirmed information is not displayed on the display 13 but outputted as voice from the voice output unit 14. For example, when the unconfirmed information is a missed call history, the voice output unit 14 outputs, for example, “incoming call from Mr. A at 14:30”, etc. as voice. This is because the user is driving the vehicle and thus has no time to pay attention to the display of the unconfirmed information.

While the vehicle is being automatically driven, the controller 4 permits display and prohibits output in voice. Since the user does not perform a special driving operation during the automatic driving, the user has time to confirm the unconfirmed information as during the stop of the vehicle.

Furthermore, the controller 4 controls the voice recognition unit 7. Specifically, the voice recognition is prohibited during the stop and the automatic driving of the vehicle, and is permitted during the manual driving of the vehicle as illustrated in FIG. 4. Accordingly, the user who has confirmed the missed call history in voice can call the incoming caller by voice input.

Although the output in voice and the voice recognition are prohibited during the automatic driving and the stop of the vehicle and are permitted during the manual driving as described in FIG. 4, the user may preset whether they are permitted or prohibited. For example, the output in voice may be permitted during the automatic driving or prohibited during the manual driving, according to settings of the user. In any of the cases, controlling display of the unconfirmed information only during the automatic driving and the stop of the vehicle produces an advantage of the present invention of notifying the user of the unconfirmed information without interfering with the driving.

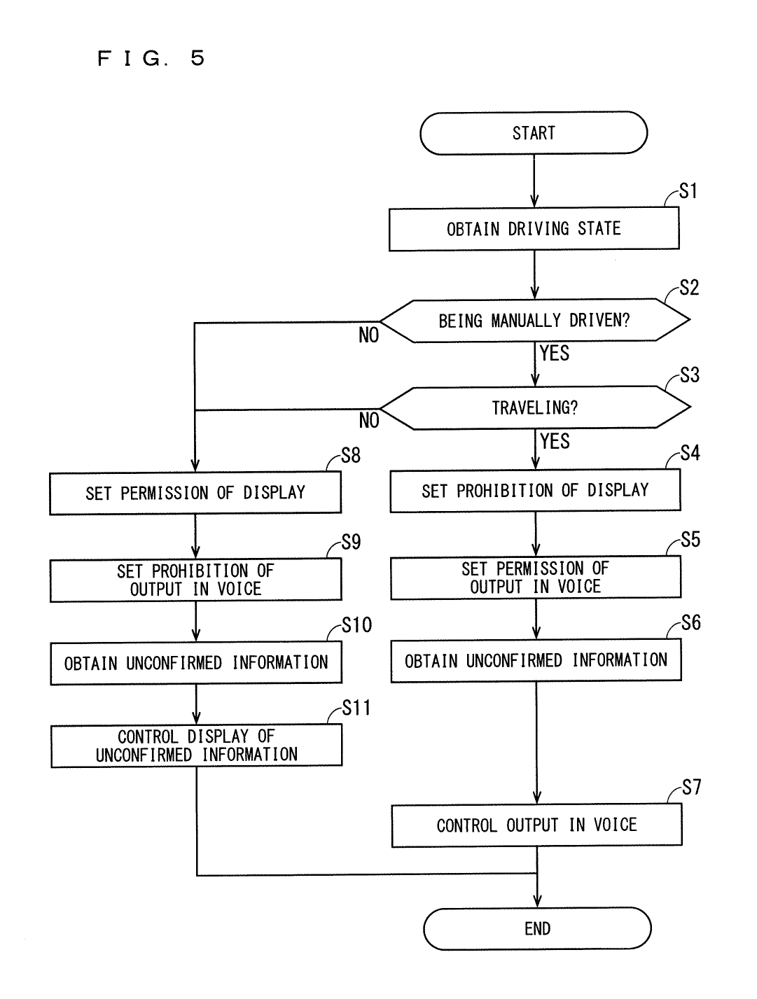

FIG. 5 is a flowchart illustrating operations of the unconfirmed-information output apparatus 102. The output control processes of the unconfirmed information by the unconfirmed-information output apparatus 102 will be hereinafter described with reference to FIG. 5. Upon power-on of the unconfirmed-information output apparatus 102 through, for example, turning ON an accessory of the vehicle, first, the driving state obtaining unit 1 obtains a driving state of the vehicle from the vehicle control device 11 (Step S1). This driving state includes a state indicating that the vehicle is traveling or stops, and a state indicating that the vehicle is being automatically or manually driven. The controller 4 obtains the driving state from the driving state obtaining unit 1, and determines whether the vehicle is being manually driven (Step S2) and whether the vehicle is traveling (Step S3) to control output. In other words, the processes proceed to Step S8 if the vehicle is being automatically driven (No at Step S2) and if the vehicle is being manually driven but stops (No at Step S3). If the vehicle is being manually driven and traveling (Yes at Step S3), the processes proceed to Step S4.

At Step S4, the controller 4 sets prohibition of display. Then, the controller 4 sets permission of output in voice (Step S5). Next, the controller 4 obtains the unconfirmed information of the carry-in terminal 12 from the communication unit 2 (Step S6), and controls output of the unconfirmed information in voice (Step S7). Accordingly, the unconfirmed information is not displayed but is notified to the user in voice during the manual driving.

At Step S8, the controller 4 sets permission of display. Then, the controller 4 sets permission of output in voice (Step S9). Next, the controller 4 obtains the unconfirmed information of the carry-in terminal 12 from the communication unit 2 (Step S10), and controls display of the unconfirmed information (Step S11). Accordingly, the unconfirmed information is notified to the user through display during the automatic driving and the stop of the vehicle.

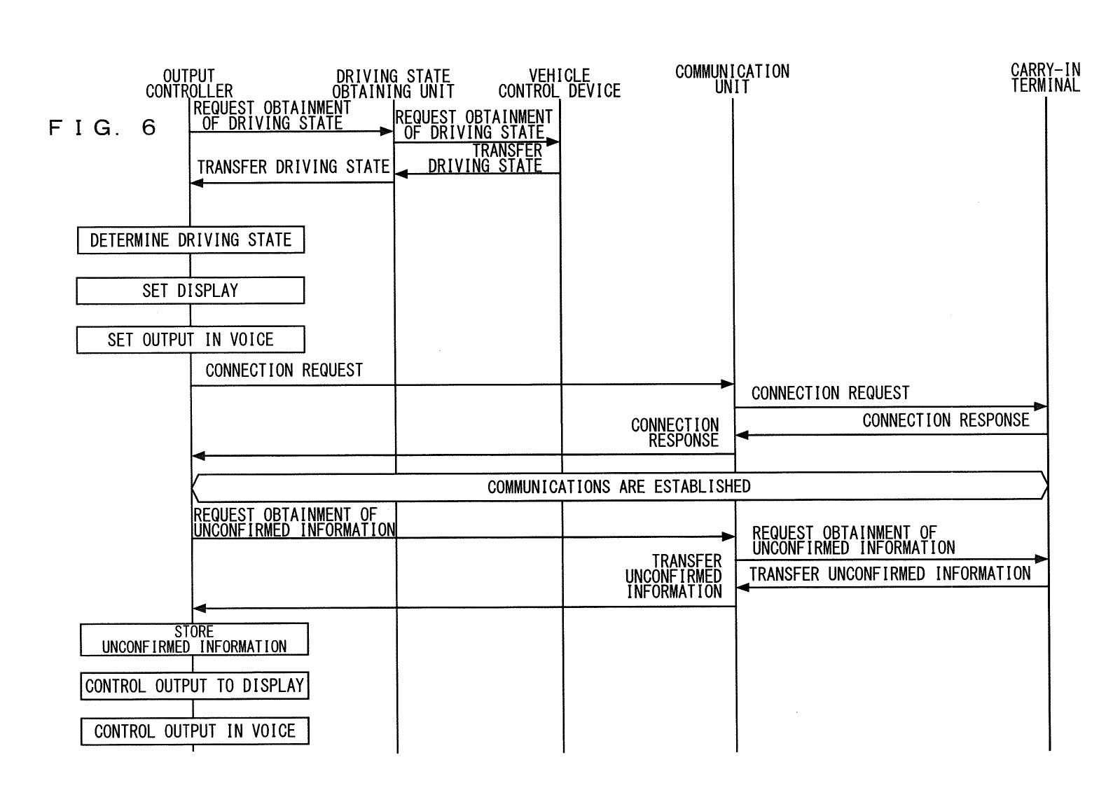

FIG. 6 is a time chart illustrating the operations of the unconfirmed-information output apparatus 102. The output control processes of the unconfirmed information by the unconfirmed-information output apparatus 102 will be hereinafter described with reference to FIG. 6. First, the output controller 3 requests the driving state obtaining unit 1 to obtain a driving state. In response to the request for obtainment of the driving state from the output controller 3, the driving state obtaining unit 1 requests the vehicle control device 11 to obtain the driving state, and obtains the driving state from the vehicle control device 11. Then, the driving state obtaining unit 1 transmits the obtained driving state to the output controller 3.

Upon receipt of the driving state, the output controller 3 determines whether the vehicle is being driven automatically or manually and whether the vehicle is traveling or stops. Then, the output controller 3 sets permission or prohibition of the display and sets permission or prohibition of output in voice, according to a result of the determination.

Furthermore, the output controller 3 issues a connection request to the communication unit 2. In response to the connection request from the output controller 3, the communication unit 2 issues a connection request to the carry-in terminal 12. Upon receipt of a connection response from the carry-in terminal 12, the communication unit 2 transmits the connection response to the output controller 3. Accordingly, communications are established between the output controller 3, the communication unit 2, and the carry-in terminal 12.

Next, the output controller 3 requests the communication unit 2 to obtain the unconfirmed information. In response to the obtainment request of the unconfirmed information from the output controller 3, the communication unit 2 requests the carry-in terminal 12 to obtain the unconfirmed information. Upon receipt of the unconfirmed information from the carry-in terminal 12, the communication unit 2 transmits the unconfirmed information to the output controller 3.

Upon obtainment of the unconfirmed information, the output controller 3 stores the unconfirmed information in a storage that is not illustrated. Then, the output controller 3 controls output to the display on the basis of the display setting, and output in voice on the basis of the voice output setting.

### [B-3. Advantages]

The unconfirmed-information output apparatus 102 according to Embodiment 2 is an apparatus mounted on a vehicle. The unconfirmed-information output apparatus 102 includes: the communication unit 2 that communicates with the carry-in terminal 12 brought into the vehicle to obtain unconfirmed information from the carry-in terminal 12; the driving state obtaining unit 1 that obtains a driving state of the vehicle; and the output controller 3 that controls output of the unconfirmed information on the basis of the driving state. Accordingly, since the unconfirmed-information output apparatus 101 controls output of the unconfirmed information on the basis of the driving state, it can output the unconfirmed information so as not to interfere with driving.

Furthermore, the driving state of the vehicle obtained by the driving state obtaining unit 1 includes a state indicating that the vehicle is traveling or stops. Then, the output controller 3 causes the display 13 not to display the unconfirmed information while the vehicle is traveling, and causes the display 13 to display the unconfirmed information during the stop of the vehicle. Accordingly, when the driver has time to gaze the display on the display 13, the unconfirmed information can be notified to the user by displaying it on the display 13.

Furthermore, the vehicle on which the unconfirmed-information output apparatus 102 is mounted can be automatically and manually driven, the driving state of the vehicle obtained by the driving state obtaining unit 1 includes a state indicating that the vehicle is being automatically or manually driven, and the output controller 3 causes the display not to display the unconfirmed information while the vehicle is being manually driven, and causes the display to display the unconfirmed information while the vehicle is being automatically driven. In other words, although the unconfirmed information is not displayed during the manual driving so that the driver can concentrate on the driving, the unconfirmed information is displayed during the automatic driving with less driving burden on the driver. Accordingly, the unconfirmed information can be output according to a driving state so as not to interfere with driving.

An unconfirmed-information output method according to Embodiment 2 includes: (a) communicating with a carry-in terminal brought into a vehicle to obtain unconfirmed information from the carry-in terminal; (b) obtaining a driving state of the vehicle; and (c) outputting the unconfirmed information to a device mounted on the vehicle, on the basis of the driving state. Accordingly, since output of the unconfirmed information is controlled on the basis of a driving state, the unconfirmed information can be output so as not to interfere with driving.

### C. Embodiment 3

### [C-1. Configuration]

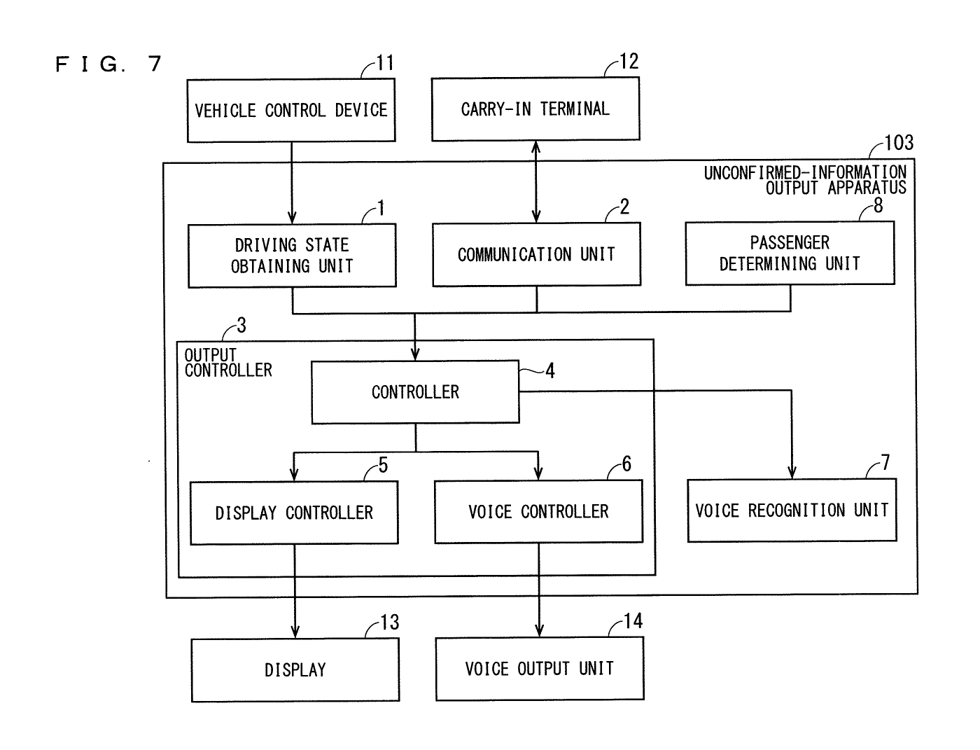

FIG. 7 is a block diagram illustrating a configuration of an unconfirmed-information output apparatus 103 according to Embodiment 3 of the present invention. The unconfirmed-information output apparatus 103 is an apparatus mounted on a vehicle similarly as the unconfirmed-information output apparatus 102, obtains unconfirmed information from the carry-in terminal 12, and outputs the unconfirmed information according to a driving state of the vehicle.

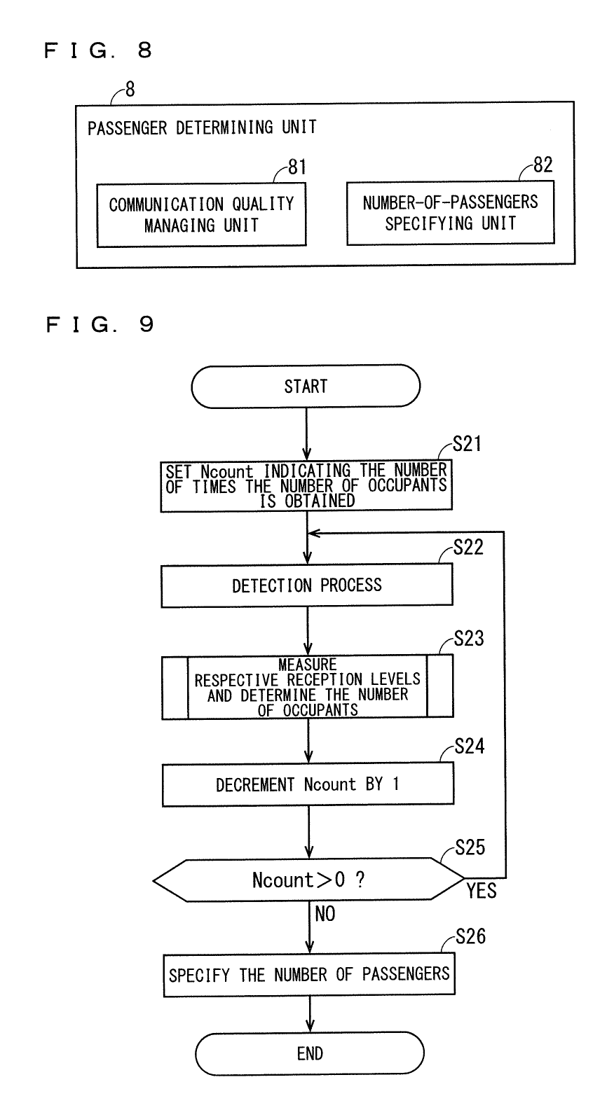

The unconfirmed-information output apparatus 103 includes an passenger determining unit 8 in addition to the configuration of the unconfirmed-information output apparatus 102. FIG. 8 is a block diagram illustrating a configuration of the passenger determining unit 8. As illustrated in FIG. 8, the passenger determining unit 8 includes a communication quality managing unit 81 that manages communication quality of the communication unit 2, and a number-of-passengers specifying unit 82 that specifies the number of passengers of the vehicle on the basis of the communication quality. The passenger determining unit 8 outputs, to the controller 4, information on the number of passengers that is specified by the number-of-passengers specifying unit 82. How to specify the number of passengers will be described later.

The controller 4 controls output of the unconfirmed information obtained from the communication unit 2, on the basis of the driving state obtained from the driving state obtaining unit 1 and determination information on the presence or absence of passengers obtained from the passenger determining unit 8. Since the other configurations are the same as those of the unconfirmed-information output apparatus 102, the description thereof will be omitted.

### [C-2. Specifying the Number of Passengers]

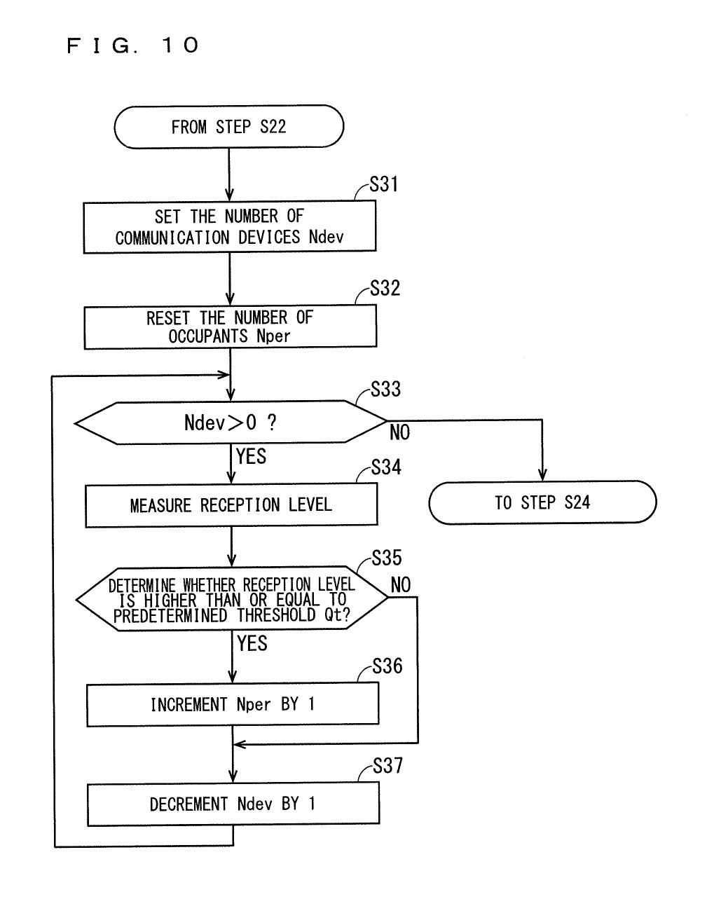

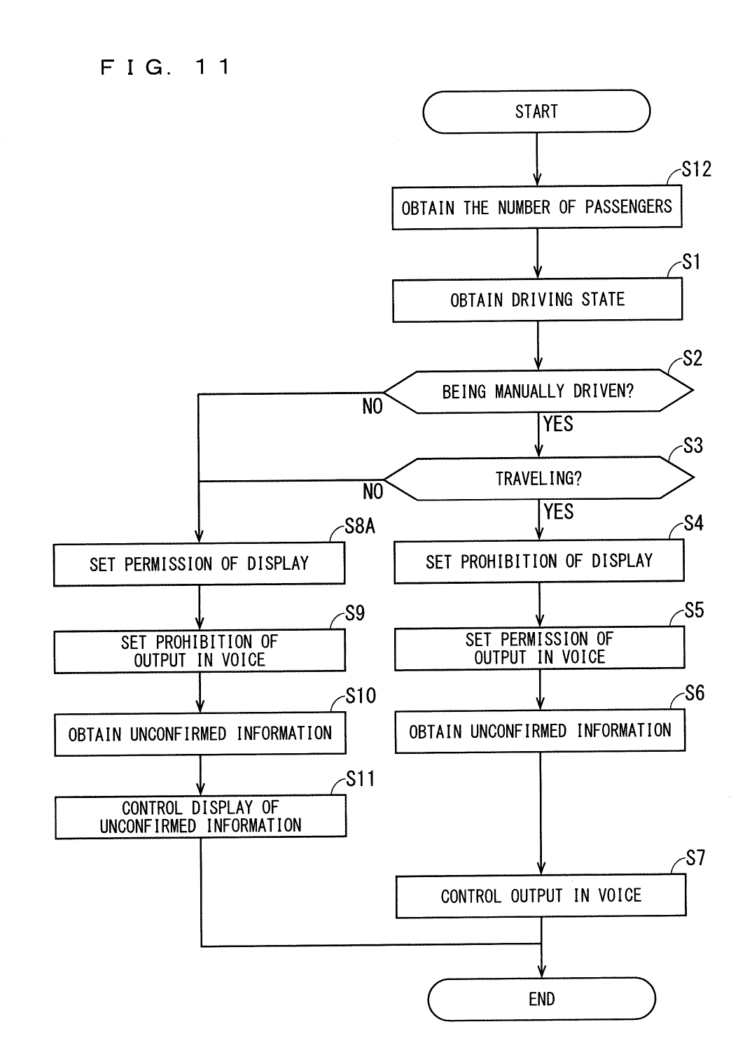

FIG. 9 is a flowchart illustrating the overall processes performed by the passenger determining unit 8, and FIG. 10 is a flowchart illustrating details of Step S23 in FIG. 9. The processes performed by the passenger determining unit 8 will be described with reference to these flowcharts.

First, the passenger determining unit 8 sets Ncount indicating how many times the number of occupants is counted (the number of times the number of occupants is obtained) to a predetermined number input by the user at Step S21 in FIG. 9. Although a case where Ncount indicating the number of times the number of occupants is obtained is set to multiple times (two or more) at this Step S21 will be described hereinafter, Ncount may be one.

The passenger determining unit 8 detects all the communication devices placed within a communication range of the communication unit 2 at Step S22. Here, it is assumed that the passenger determining unit 8 detects N communication devices.

At Step S23, the communication quality managing unit 81 measures respective reception levels of the N communication devices detected at Step S22 under the control of the passenger determining unit 8. Then, the passenger determining unit 8 determines the number of occupants in the vehicle on the basis of a result of the measurements.

Here, the processes at Step S23 will be described in detail with reference to FIG. 10. At Step S31, the passenger determining unit 8 sets the number of communication devices Ndev to a value indicating the number of communication devices detected at Step S22. If the N communication devices are detected at Step S22 as described above, the number-of-passengers specifying unit 82 sets Ndev=N.

Next, the passenger determining unit 8 resets the number of occupants Nper as 0 at Step S32.

The passenger determining unit 8 determines whether the number of communication devices Ndev is larger than 0 at Step S33. The processes proceed to Step S34 if the number of communication devices Ndev is larger than 0. The processes proceed to Step S24 in FIG. 9 if the number of communication devices Ndev is smaller than or equal to 0.

At Step S34, the communication quality managing unit 81 measures a reception level of one of the communication devices detected at Step S22. At every Step S34, the communication quality managing unit 81 measures a reception level of a communication device whose reception level has not been measured yet.

The passenger determining unit 8 determines whether the reception level measured at Step S34 is higher than or equal to a predetermined threshold Qt at Step S35. The predetermined threshold Qt is set to a value of a reception level high enough not to be detected from a communication device outside of the vehicle. The predetermined threshold Qt may be set to, for example, −60.0 [dBm] in consideration of precise detection of the number of occupants without detection of any communication device outside of the vehicle. If the passenger determining unit 8 determines that the reception level is higher than or equal to the predetermined threshold Qt, the processes proceed to Step S36. If the passenger determining unit 8 determines that the reception level is lower than the predetermined threshold Qt, the processes proceed to Step S37.

The passenger determining unit 8 increments a value of the number of occupants Nper by 1 at Step S36, and proceeds to Step S37.

The passenger determining unit 8 decrements the number of communication devices Ndev by 1 at Step S37, and returns to Step S33.

With the processes, the respective reception levels of the N communication devices detected at Step S22 are measured. Then, the number of communication devices whose reception level is higher than or equal to the predetermined threshold Qt is determined from among the N communication devices. Since the predetermined threshold Qt is set to the value of the reception level high enough not to be detected from a communication device outside of the vehicle as described above, the number of the communication devices in the vehicle is determined to be the number of occupants Nper according to the processes illustrated in FIG. 10. In other words, since the passenger determining unit 8 can prevent the number of the communication devices outside of the vehicle from being counted as the number of occupants Nper, the number of occupants can be precisely detected.

Again with reference to FIG. 9, Ncount indicating the number of times the number of occupants is obtained is decremented by 1 at Step S24 after Step S23.

The passenger determining unit 8 determines whether Ncount indicating the number of times the number of occupants is obtained is larger than 0 at Step S25. The processes return to Step S22 if Ncount indicating the number of times the number of occupants is obtained is larger than 0. The processes proceed to Step S26 if Ncount indicating the number of times the number of occupants is obtained is smaller than or equal to 0.

Since Ncount indicating the number of times the number of occupants is obtained is set to the multiple times at Step S21 as described above, the processes from Steps S22 to S25 will be performed multiple times according to Embodiment 1. In other words, the processes of measuring the reception levels by the communication quality managing unit 81 and determining the number of the communication devices (the number of occupants) by the passenger determining unit 8 will be performed multiple times.

At Step S26, the number-of-passengers specifying unit 82 specifies the number of occupants on the basis of counts of the number of occupants obtained multiple times, and specifies the number of passengers by decrementing the specified number of occupants by 1. The number-of-passengers specifying unit 82 may, for example, determine an average or the mode of the counts of the number of occupants obtained multiple times as the number of occupants specified at Step S26.

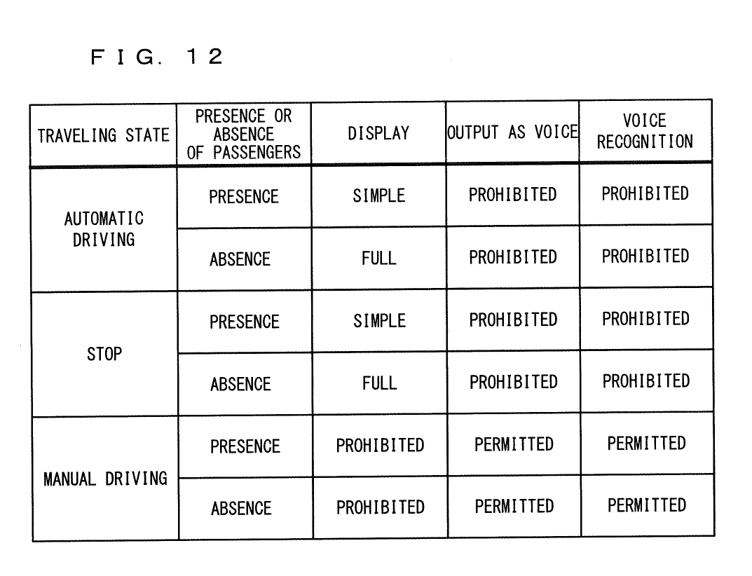

FIG. 11 is a flowchart illustrating output control processes of the unconfirmed-information output apparatus 103. The output control processes of the unconfirmed-information output apparatus 103 will be described with reference to FIG. 11. Upon power-on of the unconfirmed-information output apparatus 102 through, for example, turning ON an accessory of the vehicle, the controller 4 obtains the number of passengers from the passenger determining unit 8 (Step S12). The subsequent Steps S1 to S7 are the same as the output control processes of the unconfirmed information by the unconfirmed-information output apparatus 102.

However, the controller 4 sets permission of display depending on the presence or absence of passengers (Step S8A), during the automatic driving (No at Step S2) and during the stop (No at Step S3) of the vehicle.

FIG. 12 illustrates how the controller 4 performs control on the basis of a driving state and the presence or absence of passengers. During the automatic driving and the stop of the vehicle, the unconfirmed information is displayed in full if there is no passenger, whereas the unconfirmed information is displayed in simple if there is a passenger. In the example of the missed call history, a telop indicating, for example, “incoming call from Mr. A at 14:30” is displayed on the display 13 in full. In contrast, a telop indicating, for example, “incoming call at 14:30” is displayed in simple on the display 13 without information on the caller. Furthermore, for example, an icon of a telephone indicating the number of incoming calls may be displayed in simple besides such a telop. As such, an amount of information when displayed is less in simple than that in full. Accordingly, the unconfirmed information can be output with consideration given to the user and without notifying the passenger of specific details about the unconfirmed information.

The display is prohibited during the manual driving, irrespective of the presence or absence of passengers. Furthermore, output controls on the output in voice and the voice recognition are the same as those in Embodiment 2, irrespective of the presence or absence of passengers.

At Step S8A in FIG. 11 again, permission of display is set in accordance with FIG. 12. In other words, if the number of the passengers obtained at Step S12 is one or more, that is, if there is a passenger, the simple display is permitted. Furthermore, if the number of the passengers obtained at Step S12 is zero, that is, if there is no passenger, the full display is permitted.

Since the subsequent Steps S9 to S11 are the same as those in Embodiment 2, the description thereof will be omitted.

### [C-3. Advantages]

The unconfirmed-information output apparatus according to Embodiment 3 includes the passenger determining unit 8 that determines the presence or absence of passengers of the vehicle, wherein the output controller 3 controls output of the unconfirmed information on the basis of the driving state and the presence or absence of passengers. Thus, the privacy of the user can be taken into account by outputting the unconfirmed information with less amount of information than that when there is no passenger, for example, by displaying a missed call history without revealing the incoming caller when there is a passenger.

Embodiments of the present invention can be freely combined, and appropriately modified or omitted within the scope of the present invention.

Although this invention has been described in detail, the description is in all aspects illustrative and does not restrict the invention. Therefore, numerous modifications that have yet been exemplified will be devised without departing from the scope of this invention.

### EXPLANATION OF REFERENCE SIGNS

1 driving state obtaining unit, 2 communication unit, 3 output controller, 4 controller, 5 display controller, 6 voice controller, 7 voice recognition unit, 8 passenger determining unit, 11 vehicle control device, 12 carry-in terminal, 13 display, 14 voice output unit, 21 CPU, 22 memory, 81 communication quality managing unit, 82 number-of-passengers specifying unit, 101, 102, 103 unconfirmed-information output apparatus

1. An unconfirmed-information output apparatus, comprising:
a processor to execute a program; and
a memory to store the program which, when executed by the processor, performs processes of:
communicating with a carry-in terminal brought into a vehicle to obtain unconfirmed information from said carry-in terminal;
obtaining a driving state of said vehicle; and
controlling output of said unconfirmed information to a display or a voice output unit on a basis of said driving state, said display or said voice output unit being mounted on said vehicle,
wherein said unconfirmed-information output apparatus is mounted on said vehicle.

2. The unconfirmed-information output apparatus according to claim 1,
wherein said driving state includes a state indicating that said vehicle is traveling or stops, and
said unconfirmed-information output apparatus causes said display not to display said unconfirmed information while said vehicle is traveling, and causes said display to display said unconfirmed information during stop of said vehicle.

3. The unconfirmed-information output apparatus according to claim 2,
wherein said vehicle can be automatically and manually driven,
said driving state includes a state indicating that said vehicle is being automatically or manually driven, and
said unconfirmed-information output apparatus causes said display not to display said unconfirmed information while said vehicle is being manually driven, and causes said display to display said unconfirmed information while said vehicle is being automatically driven.

4. The unconfirmed-information output apparatus according to claim 1, wherein, when said program is executed by the processor, further performs a process of,
determining presence or absence of passengers of said vehicle,
wherein said unconfirmed-information output apparatus controls output of said unconfirmed information on a basis of said driving state and said presence or absence of passengers.

5. An unconfirmed-information output method, comprising:
(a) communicating with a carry-in terminal brought into a vehicle to obtain unconfirmed information from said carry-in terminal;
(b) obtaining a driving state of said vehicle; and
(c) outputting said unconfirmed information to a display or a voice output unit on a basis of said driving state, said display or said voice output unit being mounted on said vehicle.
